(19) United States
(12) Patent Application Publication
(10) Pub. No.: US 2023/0110089 A1
(43) Pub. Date: Apr. 13, 2023

(54) INFORMATION COLLECTION DEVICE, ROADSIDE DEVICE, AND ROAD CONDITION OBTAINING METHOD

(71) Applicant: NEC Corporation, Minato-ku, Tokyo (JP)

(72) Inventor: Kazuki OGATA, Tokyo (JP)

(73) Assignee: NEC Corporation, Minato-ku, Tokyo (JP)

(21) Appl. No.: 17/909,000

(22) PCT Filed: Mar. 27, 2020
(86) PCT No.: PCT/JP2020/013895

§ 371 Date: Sep. 2, 2022

(51) Int. Cl. G08G 1/01

(52) U.S. Cl. CPC G08G 1/0112

(57) ABSTRACT

To make it easier to grasp a road condition.

This information collection device is provided with: a recording instruction unit capable of requesting a passing vehicle to start recording of sensor data; a data request unit capable of requesting, via a first roadside device, the passing vehicle to transmit the sensor data recorded by the passing vehicle, the first roadside device being located on the downstream side of a section in which the sensor data is recorded; and a data reception unit capable of receiving the sensor data from the passing vehicle via the first roadside device.

### TECHNICAL FIELD

The present invention relates to an information collection device, a roadside device, a road condition obtaining system, and a road condition obtaining method.

### BACKGROUND ART

In road management by a local government or the like, a person in charge of the management goes to a site to grasp a road surface condition and repair the road surface upon receiving a notification from a citizen or the like. Monitoring using a video camera is also performed. A method of detecting an abnormality by obtaining a background difference image from a frame image is known. The frame image is obtained from the video camera attached in such a way as to image an area to be detected defined on a road. PTL 1 discloses a configuration in which detection accuracy of an obstacle can be improved depending on whether a traveling pattern of a vehicle traveling on the road is unnatural.

When traffic jam or the like is observed as part of traffic control, the police in each of the prefectures also performs local recognition by the nearest camera installed on a roadside.

PTL 2 discloses a configuration in which a roadside device (roadside communication device) that relays vehicle data such as time, the vehicle position, and azimuth measured by various sensors of vehicles received from vehicles traveling on a road to a central device (traffic control center) can set a data collection rate for each road and perform a data thinning process.

### CITATION LIST

### Patent Literature

PTL 1 JP 2017-33479 A
PTL 2 JP 2016-110608 A

### SUMMARY OF INVENTION

### Technical Problem

The following analysis was given by the inventor. As described in PTL 1, there is a problem that an accurate condition cannot be grasped by observation with a fixed point camera or the like (see, for example, paragraph 0006 of PTL 1.).

As advanced driver-assistance systems (ADAS) and automatic driving develop in the future, it is expected that infrastructure represented by roadside devices will be enhanced. It has also been studied to collect and manage various sensor data mounted on an automobile on the cloud side using these infrastructures.

However, in order to use the above data for road management, there is a problem that it is necessary to prepare a processing base capable of processing data transmitted from these enormous number of vehicles. PTL 2 proposes thinning of vehicle data by setting a data collection rate, but in a case where detailed data of any sections of a road is desired, the thinning process is rather inconvenient.

An object of the present invention is to provide an information collection device, a roadside device, a road condition obtaining system, and a road condition obtaining method capable of grasping a condition of any sections of a road at low cost.

### Solution to Problem

According to a first viewpoint, provided is an information collection device including a recording instruction unit capable of requesting a passing vehicle to start recording of sensor data, a data request unit capable of requesting the passing vehicle to transmit, via a first roadside device, the sensor data recorded by the passing vehicle, the first roadside device being located on the downstream side of a section in which the sensor data is recorded, and a data reception unit capable of receiving the sensor data from the passing vehicle via the first roadside device.

According to a second viewpoint, provided is a roadside device including a data request unit capable of requesting a passing vehicle to transmit the sensor data recorded by the passing vehicle in response to a request from the information collection device, a data reception unit capable of receiving the sensor data from the passing vehicle, and a data transmission unit capable of transmitting, to the information collection device, the sensor data received from the passing vehicle.

According to a third viewpoint, provided is a road condition obtaining system including the information collection device described above and the roadside device described above.

According to a fourth viewpoint, provided is a road condition collection method including requesting a passing vehicle to transmit recorded sensor data via a first roadside device, and receiving the sensor data from the vehicle via the first roadside device to collect the sensor data of any road sections. The method is linked to a specific machine, that is, a device for obtaining sensor data from a passing vehicle.

### Advantageous Effects of Invention

According to the present invention, it is possible to construct a system capable of grasping a condition of any sections of a road at low cost.

### BRIEF DESCRIPTION OF DRAWINGS

FIG. 1 is a diagram illustrating a configuration of an example embodiment of the present invention.

FIG. 2 is a diagram for explaining an operation of an example embodiment of the present invention.

FIG. 3 is a diagram illustrating a configuration of a road condition obtaining system according to a first example embodiment of the present invention.

FIG. 4 is a functional block diagram illustrating a configuration of an information collection device according to the first example embodiment of the present invention.

FIG. 5 is a functional block diagram illustrating a configuration of a roadside device according to the first example embodiment of the present invention.

FIG. 6 is a sequence diagram illustrating an operation of the road condition obtaining system according to the first example embodiment of the present invention.

FIG. 7 is a diagram for explaining a procedure for checking a state of a road surface using the road condition obtaining system according to the first example embodiment of the present invention.

FIG. 8 is a diagram for explaining a procedure for checking a state of a road surface using the road condition obtaining system according to the first example embodiment of the present invention.

FIG. 9 is a diagram for explaining a procedure for checking a traffic jam condition using the road condition obtaining system according to the first example embodiment of the present invention.

FIG. 10 is a diagram for explaining a procedure for checking a traffic jam condition using the road condition obtaining system according to the first example embodiment of the present invention.

FIG. 11 is a diagram illustrating a configuration of the road condition obtaining system according to the first example embodiment of the present invention.

FIG. 12 is a sequence diagram illustrating an operation of the road condition obtaining system according to the first example embodiment of the present invention.

FIG. 13 is a diagram illustrating a configuration of a computer that can function as the information collection device or the roadside device of the present invention.

### EXAMPLE EMBODIMENT

First, an outline of an example embodiment of the present invention will be described with reference to the drawings. The reference numerals in the drawings attached to this outline are attached to the respective elements for convenience as an example for assisting understanding. It is not intended to limit the invention to the illustrated aspects. Connection lines between blocks in the drawings and the like referred to in the following description include both bidirectional and unidirectional. The unidirectional arrow schematically indicates a flow of a main signal (data), and does not exclude bidirectionality. Although there are ports and interfaces at connection points of input to output of each block in the drawing, they are not illustrated. In the following description, “A and/or B” is used to mean at least any of A and B.

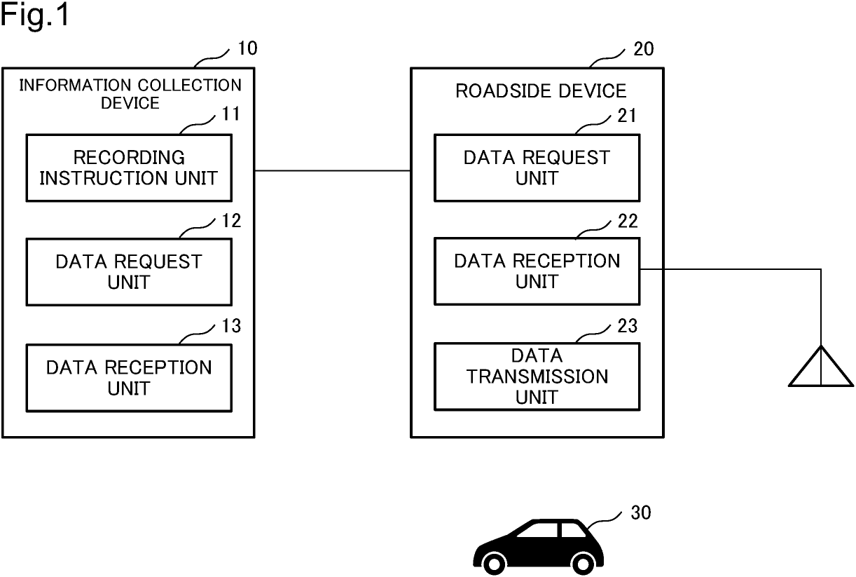

In the example embodiment of the present invention, as illustrated in FIG. 1, the present invention can be achieved by a configuration capable of collecting sensor data from a vehicle 30 using an information collection device 10 and a roadside device 20.

More specifically, the information collection device 10 includes a recording instruction unit 11, a data request unit 12, and a data reception unit 13. The recording instruction unit 11 is configured to be able to request the passing vehicle 30 to start recording of sensor data. The data request unit 12 is configured to be able to request the passing vehicle 30 to transmit the sensor data recorded by the passing vehicle via the (first) roadside device 20 located on the downstream side of the section in which the sensor data is recorded. The data reception unit 13 receives sensor data from the passing vehicle 30 via the (first) roadside device 20.

On the other hand, the roadside device 20 includes a data request unit 21, a data reception unit 22, and a data transmission unit 23. The data request unit 21 is configured to be able to request the passing vehicle 30 to transmit sensor data recorded by the passing vehicle 30 in response to a request from the information collection device 10. The data reception unit 22 is configured to be able to receive sensor data from the passing vehicle 30. The data transmission unit 23 is configured to be able to transmit sensor data received from the passing vehicle 30 to the information collection device.

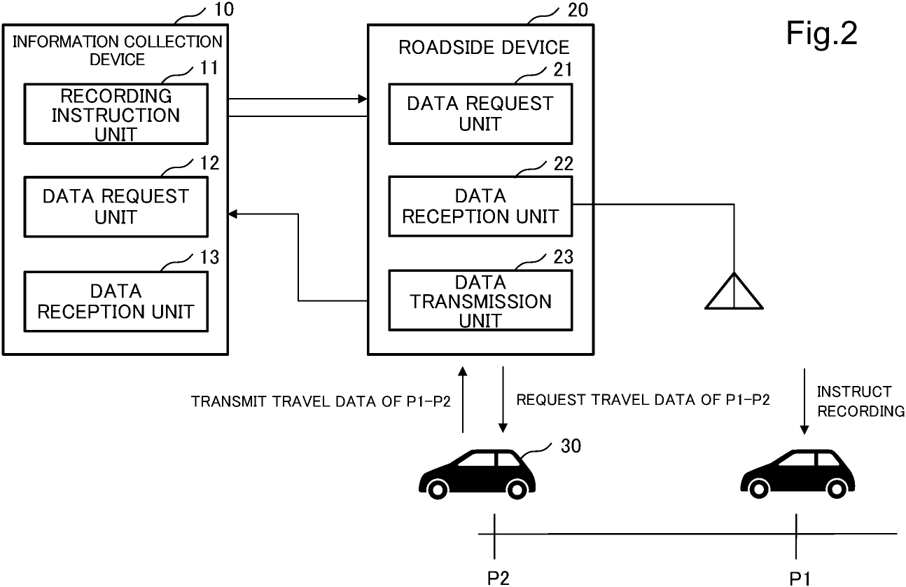

The recording instruction unit 11 of the information collection device 10 configured as described above requests the passing vehicle 30 traveling in the direction toward the point P2 from the point P1 that is a section in which the sensor data is to be obtained to start recording the sensor data based on the instruction from the user or the schedule set in advance (recording instruction in FIG. 2). The instruction (request) to start recording of the sensor data can be sent from a control center (not illustrated) or a roadside device.

Thereafter, the data request unit 12 of the information collection device 10 requests the passing vehicle 30 to transmit sensor data recorded by the passing vehicle via the (first) roadside device 20 located on the downstream side of the section in which the sensor data is recorded (requests travel data of P1-P2 in FIG. 2). Then, the data reception unit 13 of the information collection device 10 receives sensor data from the passing vehicle 30 via the (first) roadside device 20 (transmits travel data of P1-P2 in FIG. 2).

When the above operation is viewed from the roadside device 20, the data request unit 21 of the roadside device 20 requests the passing vehicle 30 to transmit sensor data recorded by the passing vehicle in response to a request from the information collection device 10. When the data reception unit 22 receives sensor data from the passing vehicle 30, the roadside device 20 transmits the sensor data received from the passing vehicle 30 to the information collection device 10 by the data transmission unit 23.

The combination of the information collection device 10 and the roadside device 20 operating as described above facilitates grasping the condition of any sections of the road. As the sensor data, various pieces of data such as distance measurement data by light detection and ranging (LiDAR), travel data of the vehicle, and the like in addition to data imaged by various cameras mounted on the vehicle can be considered. For example, by obtaining the vehicle location information in the travel data, the speed of the vehicle can be known, and when unnatural deceleration repeatedly occurs at a specific place in the designated section, it is possible to grasp that there is an abnormality on the road surface in the vicinity thereof or that there is a foreign substance. When there is a place to be checked as a result of obtaining the travel data from the first vehicle, it is possible to request the second vehicle to record the image data of the place and send the image data.

### First Example Embodiment

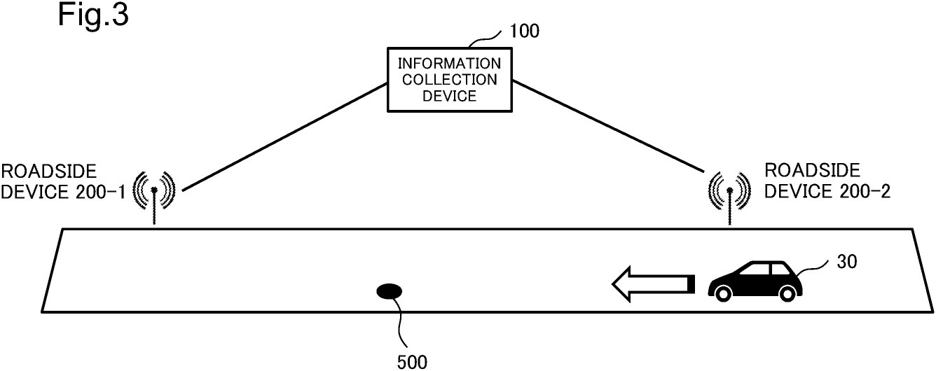

Next, a first example embodiment of the present invention will be described in detail with reference to the drawings. FIG. 3 is a diagram illustrating a configuration of a road condition obtaining system according to the first example embodiment of the present invention. Referring to FIG. 3, roadside devices 200-1 and 200-2 installed on roads and an information collection device 100 connected to the roadside devices 200-1 and 200-2 are illustrated. In the following description, an example of checking a small depression 500 of a road using sensor data obtained from a vehicle 300 will be described.

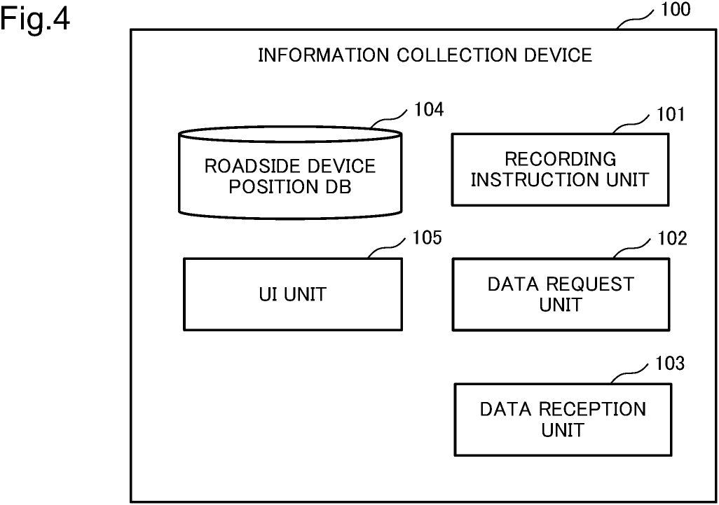

FIG. 4 is a functional block diagram illustrating a configuration of the information collection device 100 according to the first example embodiment of the present invention. Referring to FIG. 4, a configuration including a recording instruction unit 101, a data request unit 102, a data reception unit 103, a roadside device position database (roadside device position DB) 104, and a user interface (UI) unit 105 is illustrated.

The roadside device position DB 104 is a database that stores detailed information including positions of roadside devices to be managed, including the roadside devices 200-1 and 200-2.

The UI unit 105 includes a display device and an input means, and is a means for receiving designation of a section in which a user (a road administrator, a person in charge of traffic control, or the like) wants to know a condition of a road and sensor data that the user wants to obtain. For example, the UI unit 105 can be configured by a tablet device that presents map information obtained by plotting the position of a roadside device on a map to the user and receives designation of a section in which the user wants to know the condition of the road and sensor data that the user wants to obtain with a pointing device or the like. The UI unit 105 also functions as a display means of the sensor data received by the data reception unit 103.

The recording instruction unit 101 selects a roadside device located in the vicinity of the start point of the section in which the condition of the road is desired to be known based on the content received by the UI unit 105, and instructs the roadside device to request the vehicle 300, which is a passing vehicle, to start recording. The instruction can include a type of sensor data instructing start of recording and a section in which the sensor data is recorded.

Based on the content received by the UI unit 105, the data request unit 102 selects a roadside device located in the vicinity of the end point of the section in which the condition of the road is required to be known, and requests to extract (obtain) sensor data from the vehicle 300 that has been instructed to start the recording. In a case where a section in which the user wants to know the condition of the road is received from the user, a method of directly designating the section of the road displayed on the UI unit 105 by drag operation or the like can be used. As another method, a method of designating a section using a roadside device or a landmark, or a method of designating a section using a distance from a roadside device or a landmark may be enabled. For example, fine designation such as a start point: a position 40 m away from the roadside device 200-2 toward the roadside device 200-1, and an end point: a position 10 m away from the roadside device 200-1 toward the roadside device 200-2 may be made.

The data reception unit 103 receives sensor data transmitted from the vehicle 300 that has been instructed to start the recording from a roadside device that has requested the extraction of the data.

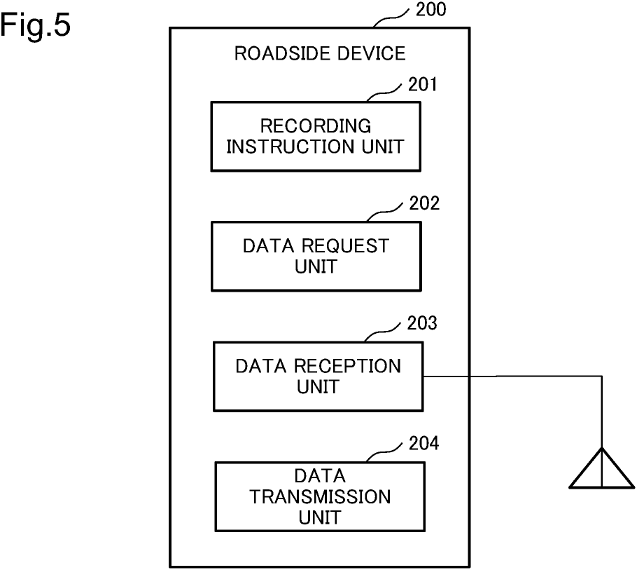

FIG. 5 is a functional block diagram illustrating a configuration of the roadside devices 200-1 and 200-2 according to the first example embodiment of the present invention. In the following description, the roadside devices 200-1 and 200-2 are referred to as the roadside device 200 unless otherwise distinguished.

Referring to FIG. 5, a configuration including a recording instruction unit 201, a data request unit 202, a data reception unit 203, and a data transmission unit 204 is illustrated.

The recording instruction unit 201 requests the vehicle 300 to record the sensor data based on the content instructed from the recording instruction unit 101 of the information collection device 100. When a section is designated using a distance from a roadside device or a landmark, the recording instruction unit 201 transmits the section to the vehicle side 30. For example, in a case where detailed designation is made for a section by the user, the recording instruction unit 201 requests the vehicle 300 that is a passing vehicle to record data including at least the section.

The data request unit 202 requests the vehicle 300 to transmit sensor data based on the content instructed from the data request unit 102 of the information collection device 100.

The data reception unit 203 receives sensor data from the vehicle 300 that has been requested to transmit the sensor data.

The data transmission unit 204 transmits the sensor data received from the vehicle 300 to the information collection device 100.

The vehicle 300 serving as a passing vehicle has a function of recording sensor data during traveling and storing the sensor data in a predetermined recording medium for a certain period of time in response to a request from the roadside device 200-2. The vehicle 300 has a function of transmitting the recorded sensor data to the roadside device in response to a request from the roadside device 200-1. In the case of moving image data obtained by capturing the image of road conditions before and after traveling, the recording medium can, for example, include a drive recorder, a recording medium for a car navigation device, or the like provided in the vehicle 300.

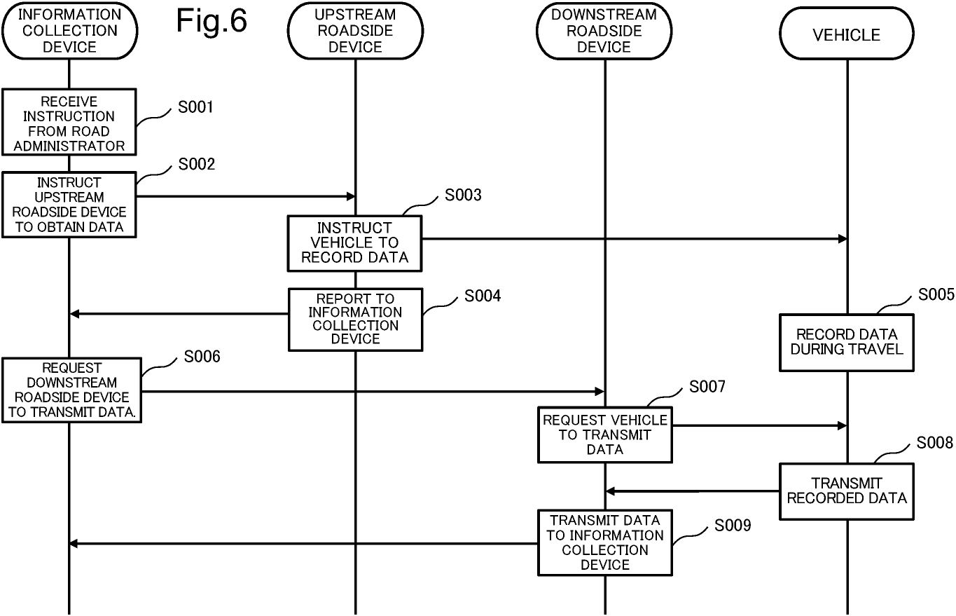

Next, the operation of the present example embodiment will be described in detail with reference to the drawings. FIG. 6 is a sequence diagram illustrating an operation of the road condition obtaining system according to the first example embodiment of the present invention. Referring to FIG. 6, first, the information collection device 100 receives an instruction including information (sensor data) desired to be obtained and information about a section in which the information (sensor data) is obtained from a road administrator or the like (step S001). Here, in order to grasp the road surface condition between the roadside device 200-2 and the roadside device 200-1 in FIG. 3, it is assumed that a camera for capturing an image in front of the vehicle 300 is selected.

The information collection device 100 that has received the instruction refers to the roadside device position DB 104 and selects the roadside device 200-2 corresponding to an upstream roadside device in the section. Then, the information collection device 100 transmits a data acquisition instruction to the roadside device 200-2 (step S002).

The roadside device 200-2 that has received the data acquisition instruction transmits, to the vehicle 300, an instruction to record information (sensor data, hereinafter also simply referred to as “data”.) requested by the road administrator or the like (step S003; see “data recording instruction” in FIG. 4). The vehicle 300 to which the data recording instruction is transmitted here may not be all passing vehicles. For example, it may be a vehicle of a public transportation facility or a business vehicle of a specific company that has expressed to cooperate with data recording. When the traffic volume is small, the roadside device 200-2 waits for a certain period of time for transmission of the data recording instruction until the vehicle 300 capable of obtaining necessary information passes.

Next, the roadside device 200-2 reports, to the information collection device 100, that transmission of a data recording instruction to the vehicle 300 has been completed (step S004). As a result, the information collection device 100 can grasp the timing at which data is transmitted to the downstream roadside device. At the time of the report, the roadside device 200-2 may notify the information collection device 100 of the ID or the like of the vehicle 300 that has been instructed to record data.

On the other hand, the vehicle 300 that has received the data recording instruction from the roadside device 200-2 activates the sensor as necessary while traveling in the section, and records data (step S005).

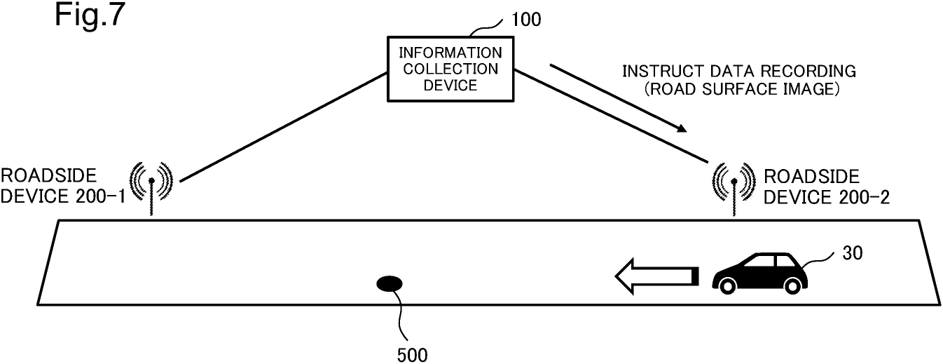

As a result, as illustrated in FIG. 7, capturing an image to grasp the small depression 500 of the road using the vehicle 300 is started.

Thereafter, the information collection device 100 refers to the roadside device position DB 104 based on the report received in step S004, and requests the roadside device 200-1 corresponding to the downstream roadside device in the section to transmit the recorded data (step S006). In step S004, when a notification such as the ID of the vehicle that has been instructed to record data is received from the roadside device 200-2, the information collection device 100 may identify the vehicle that the roadside device 200-1 requests to transmit data to by using the ID of the vehicle.

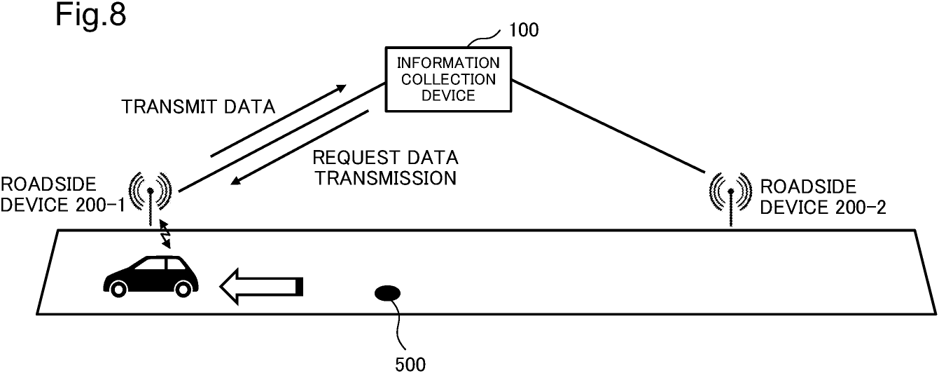

The roadside device 200-1 that has received the data transmission request requests the vehicle 300 to transmit data recorded during traveling (step S007; see “data transmission request” in FIG. 8).

The vehicle 300 that has received the data transmission request transmits, to the roadside device 200-1, data recorded while traveling in the section (step S008).

The roadside device 200-1 that has received the data from the vehicle 300 transmits the data received from the vehicle 300 to the information collection device 100 (step S009; see “data transmission” in FIG. 8).

As described above, the road administrator obtains data received from the vehicle 300 via the information collection device 100 and the roadside device 200, and can grasp the detailed position and condition of the small depression 500 on the road between the roadside devices 200-2 and 200-1. Of course, it is also effective to receive data from a plurality of vehicles for the same section. Furthermore, different types of data can be transmitted from a plurality of vehicles for the same section.

In the example embodiment of the first example embodiment, an example used for road management is described, but the application range of the present invention is not limited thereto. Hereinafter, some suitable application examples of the present invention will be described.

### Check of Condition of Opposite Lane for Opposite Traffic

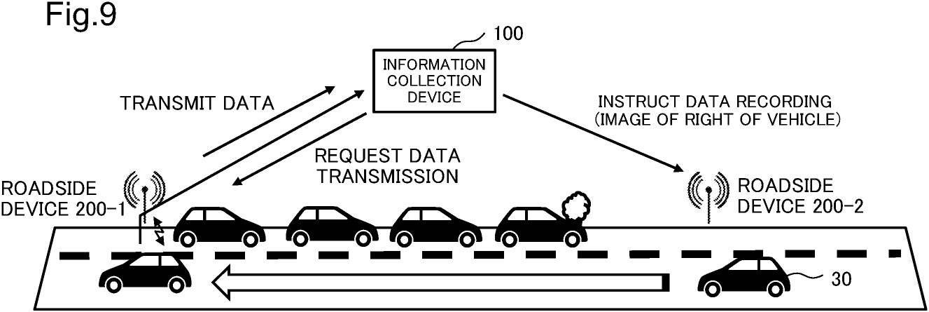

FIG. 9 illustrates a condition in which a traffic jam occurs in a lane from the left side to the right side of the opposite traffic. In general, in a probe car, since the probe car itself is caught in a traffic jam, it takes time to grasp the cause of the traffic jam. On the other hand, the present invention can be suitably applied to a case where the lane from the right side to the left side is relatively vacant.

The person in charge of traffic control who has checked the occurrence of traffic jam requests the vehicle 300 to capture and transmit an image of right of the vehicle via the roadside device 200-2. As a result, the person in charge of traffic control can check that there is a failed vehicle at the head of the congested lane, and can make necessary arrangements such as dispatch of a police officer and dispatch of a tow truck.

### Condition Checking of Congested Lane

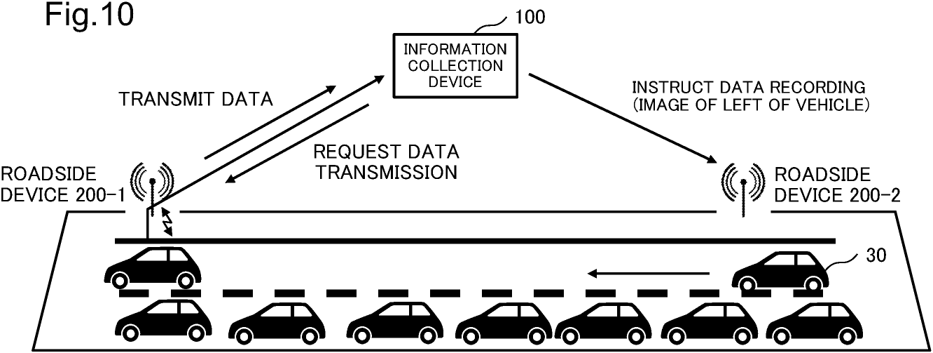

FIG. 10 illustrates a condition in which a traffic jam occurs in a left lane from the right side to the left side of two lanes. On the other hand, the central side lane of the two lanes are relatively vacant. The cause of the traffic jam on the left lane includes a case where traffic jam occurs in a left turn direction of a road intersecting at the intersection ahead of the vehicle, a case where traffic jam occurs due to a vehicle that can not enter a store parking lot on the left side of the road, and the like, but it is difficult for a fixed monitoring camera to grasp this point. The present invention can also be suitably applied to such a case.

The person in charge of traffic control who has checked the occurrence of traffic jam requests the vehicle 300 to capture and transmit an image of left of the vehicle via the roadside device 200-2. As a result, the person in charge of traffic control can check that the cause of the congested lane is not a so-called left turn congestion at an intersection but is caused by a vehicle trying to enter a store parking lot on the left side of the road. Also in this case, the person in charge of traffic control can request the store to arrange the parking lot and display the traffic jam information on the road information display device installed before the traffic jam.

The above example is merely an example to which the present invention is applied, and the present invention can be used for various purposes by changing the type of sensor data obtained from the vehicle 300. For example, by recording a communication status with a roadside device different from the roadside devices 200-1 and 200-2 and transmitting the communication status to the information collection device 100, it can also be used for checking whether the different roadside device are operating normally.

### Second Example Embodiment

Next, the second example embodiment in which the upstream roadside device in the first example embodiment can be omitted will be described. In the first example embodiment described above, the case in which the vehicle 300 records sensor data each time described that, but there is a case where the vehicle 300 records various types of sensor data based on an instruction from a control center or the like for automatic driving or advanced driver-assistance systems (ADAS). In such a case, the data recording instruction from the upstream roadside device of the first example embodiment can be omitted.

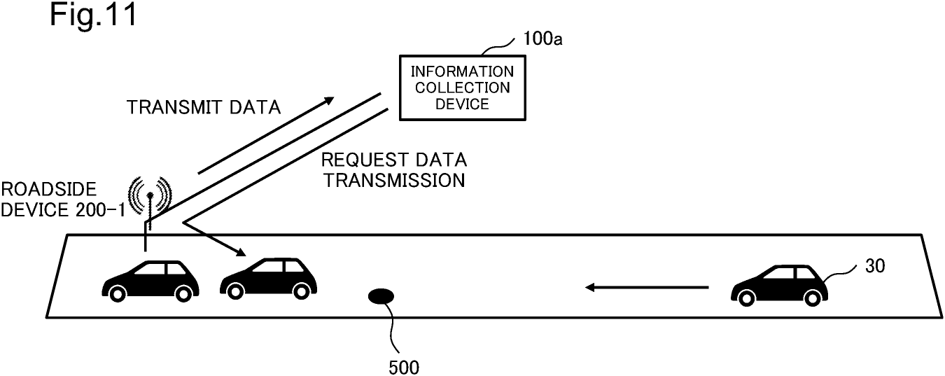

FIG. 11 is a diagram illustrating a configuration of a road condition obtaining system according to the second example embodiment of the present invention. Referring to FIG. 11, the roadside device 200-1 installed on a road and an information collection device 100a connected to the roadside device 200-1 are illustrated. In the following description, an example of checking a small depression 500 of a road using sensor data obtained from a vehicle 300 will be described. Since the basic configurations of the information collection device 100a and the roadside device 200-1 are similar to those of the first example embodiment, differences thereof will be mainly described below.

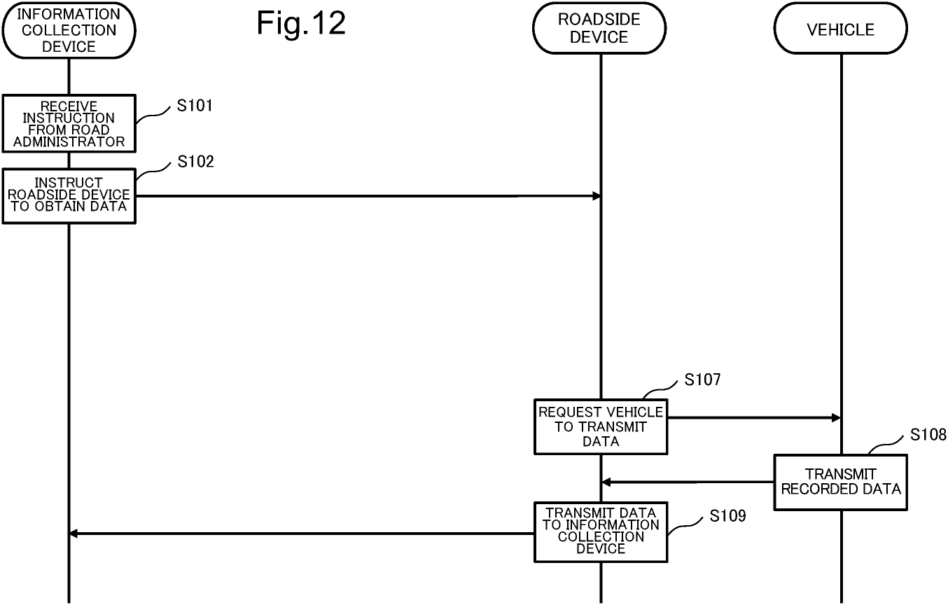

FIG. 12 is a sequence diagram illustrating an operation of the road condition obtaining system according to the second example embodiment of the present invention. Referring to FIG. 12, first, the information collection device 100a receives an instruction including information desired to be obtained and information about a section in which the information is obtained from a road administrator or the like (step S101). In the present example embodiment, in designating the section in which the information is obtained, only the roadside device 200 and the direction of the road on which the data is obtained may be designated. In this case, a predetermined distance upstream from the designated roadside device can be treated as a section in which information is obtained.

The information collection device 100a that has received the instruction refers to the roadside device position DB 104 and requests the roadside device 200-1 corresponding to a downstream roadside device in the section to transmit recorded data (step S102).

Upon receiving the data transmission request, the roadside device 200-1 requests the vehicle 300 to transmit data recorded during traveling (step S107; see “data transmission request” in FIG. 11).

The vehicle 300 that has received the data transmission request transmits data recorded while traveling in the section to the roadside device 200-1 (step S108).

The roadside device 200-1 that has received the data from the vehicle 300 transmits, to the information collection device 100a, the data received from the vehicle 300 (step S109; see “data transmission” in FIG. 11).

As described above, the road administrator obtains data received from the vehicle 300 via the information collection device 100a and the roadside device 200-1, and can grasp the detailed position and condition of the small depression 500 on the road between the roadside devices 200-2 and 200-1.

Although the example embodiments of the present invention have been described above, the present invention is not limited to the above-described example embodiments, and further modifications, substitutions, and adjustments can be made without departing from the basic technical idea of the present invention. For example, the device configuration, the configuration of respective elements, and the expression form of data and the like illustrated in the drawings are examples for assisting the understanding of the present invention, and are not limited to the configurations illustrated in the drawings. For example, in the first example embodiment described above, an example in which two roadside devices are installed is described, but the number of roadside devices is not limited.

For example, in the above-described example embodiment, the case in which each of the information collection devices 100 and 100a is disposed independently is described, but each of the information collection devices 100 and 100a can be installed in an integrated manner with other devices. For example, each of the information collection devices 100 and 100a described above can also be achieved as one function of a control device of a traffic control center.

Various methods can be used as a communication method between the roadside device 200 and the vehicle 300. For example, the roadside device 200 and the vehicle 300 may communicate with each other using dedicated short range communications (DSRC) used in an electronic toll collection system (ETC). In addition, for example, the roadside device 200 and the vehicle 300 may communicate with each other using an ITS Connect standard defined by association of radio industries and businesses (ARIB). In addition, for example, the roadside device 200 and the vehicle 300 may communicate with each other using NR5G defined in a third generation partnership project (3GPP).

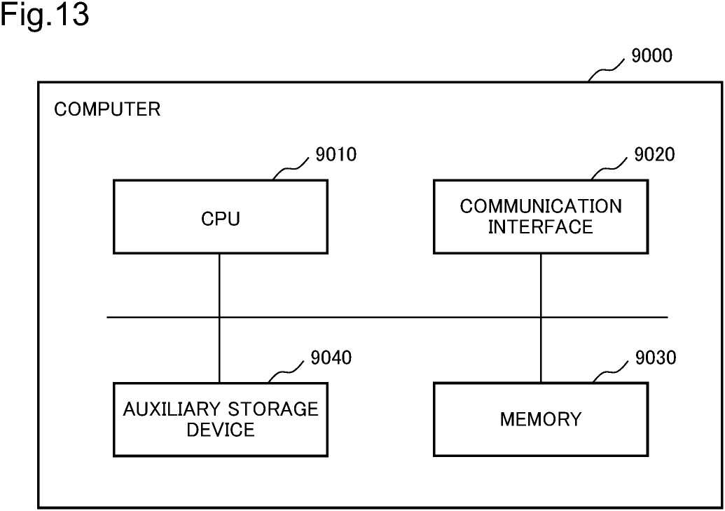

The procedure described in each of the above example embodiments can be implemented by a program for causing a computer (9000 in FIG. 13) that functions as an information collection device or a roadside device to implement functions of these devices. Such a computer is exemplified in a configuration including a central processing unit (CPU) 9010, a communication interface 9020, a memory 9030, and an auxiliary storage device 9040 in FIG. 13. That is, the vehicle type determination program and the information providing program may be executed by the CPU 9010 of FIG. 13.

That is, each unit (processing means and function) of the information collection devices 100 and 100a described above can be achieved by a computer program that causes a processor mounted on these devices to execute each processing described above using the hardware.

Finally, preferred forms of the invention are summarized.

### First Embodiment

(See the information collection device according to the first viewpoint)

### Second Embodiment

The recording instruction unit of the information collection device described above may be configured to request the passing vehicle to start recording the sensor data via a second roadside device upstream of the first roadside device.

### Third Embodiment

The above-described information collection device may be configured to be capable of designating, via the second roadside device, a type of the sensor data to be recorded for the passing vehicle.

### Fourth Embodiment

The information collection device described above may be configured to be capable of designating, via the second roadside device, a section in which the sensor data is recorded for the passing vehicle.

### Fifth Embodiment

The above-described information collection device may be configured to collect, as sensor data, data for checking a road surface condition of a road on which the passing vehicle passes.

### Sixth Embodiment

The information collection device described above may be configured to collect, as sensor data, data for checking a traffic jam condition of a road on which the passing vehicle passes.

### Seventh Embodiment

(See the roadside device according to the second viewpoint)

### Eighth Embodiment

(See the road condition obtaining system according to the third viewpoint)

### Ninth Embodiment

(The road condition collection method according to the fourth viewpoint)

The seventh to ninth embodiments can be developed into the second to sixth embodiments as in the first embodiment.

The disclosure of the above Patent Literatures is incorporated herein by reference. Within the frame of the entire disclosure (including the claims) of the present invention, it is possible to change and adjust the example embodiments and examples further based on the basic technical idea thereof. Various combinations or selections (including partial deletions) of various disclosure elements (respective elements of each claim, respective elements of each example embodiment and example, respective elements of each drawing, and the like are included.) can be made within the frame of the disclosure of the present invention. That is, it is a matter of course that the present invention includes various modifications and corrections that can be made by those skilled in the art in accordance with the entire disclosure including the claims and the technical idea. Specifically, for numerical ranges set forth herein, any numerical value or sub-range included within the range should be construed as being specifically described, even when not stated otherwise.

### REFERENCE SIGNS LIST

10, 100 information collection device
11, 101 recording instruction unit
12, 102 data request unit
13, 103 data reception unit
20, 200-1, 200-2 roadside device
21 data request unit
22 data reception unit
23 data transmission unit
21, 202 data request unit
22, 203 data reception unit
23, 204 data transmission unit
30 passing vehicle
104 roadside device position database (roadside device position DB)
105 UI (user interface) unit
201 recording instruction unit
300 passing vehicle
9000 computer
9010 CPU
9020 communication interface
9030 memory
9040 auxiliary storage device

What is claimed is:

1. An information collection device comprising:
one or more memories storing instructions; and
one or more processors configured to execute the instructions to:
request a passing vehicle to start recording of sensor data;
request the passing vehicle to transmit, via a first roadside device, the sensor data recorded by the passing vehicle, wherein the sensor data is recorded in a section of a road, and wherein the first roadside device is located on a downstream side of the section; and
receive the sensor data from the passing vehicle via the first roadside device.

2. The information collection device according to claim 1, wherein the one or more processors configured to execute the instructions to:
request the passing vehicle to start recording the sensor data via a second roadside device located on an upstream side from the first roadside device.

3. The information collection device according to claim 2, wherein the one or more processors configured to execute the instructions to:
designate, via the second roadside device, a type of the sensor data to be recorded for the passing vehicle.

4. The information collection device according to claim 2, wherein the one or more processors configured to execute the instructions to:
designate, via the second roadside device, a section in which the sensor data is recorded for the passing vehicle.

5. The information collection device according to claim 1, wherein the sensor data is data for checking a road surface condition of a road on which the passing vehicle passes.

6. The information collection device according to claim 1, wherein the sensor data is data for checking a traffic jam condition of the road on which the passing vehicle passes.

7. A roadside device comprising:
one or more memories storing instructions; and
one or more processors configured to execute the instructions to:
request a passing vehicle to transmit sensor data recorded by the passing vehicle in response to a request from an information collection device;
receive the sensor data from the passing vehicle; and
transmit, to the information collection device, the sensor data received from the passing vehicle.

8. (canceled)

9. A road condition collection method comprising:
requesting a passing vehicle to start recording of sensor data;
requesting the passing vehicle to transmit, via a first roadside device, the sensor data recorded by the passing vehicle, wherein the sensor data is recorded in a section of a road, and wherein the first roadside device is located on a downstream side of the section; and
receiving the sensor data from the passing vehicle via the first roadside device to collect the sensor data in any sections.
